(19) United States
(12) Patent Application Publication
(10) Pub. No.: US 2007/0259990 A1
(43) Pub. Date: Nov. 8, 2007

(54) TIRE TREATMENT COMPOSITION, PROCESS AND PACKAGING

(75) Inventors: Harvey Katz, Boca Raton, FL (US); Claudia Iovino, Boca Raton, FL (US); Stephen Bradway, Boca Raton, FL (US); Richard Iantosca, Boynton Beach, FL (US); Wei R. Chen, Edmond, OK (US)

Correspondence Address: FELLERS SNIDER BLANKENSHIP;BAILEY & TIPPENS, THE KENNEDY BUILDING, 321 SOUTH BOSTON SUITE 800, TULSA, OK, 74103-3318, US

(73) Assignee: TRANS GLOBAL CHEMICAL, LLC, Delray Beach, FL (US)

(21) Appl. No.: 11/745,101

(22) Filed: May 7, 2007

Related U.S. Application Data
(60) Provisional application No. 60/798,250, filed on May 5, 2006.

(51) Int. Cl. B29C 73/00

(52) U.S. Cl. 523/166

(57) ABSTRACT

A tire treatment composition including a solid material suspended in a liquid carrier. The solid material consists of at least one ceramic fiber component and a blend of polymeric fibers. The polymeric fibers include various mixtures of polyethylene and/or polypropylene, polyester, polymeric acrylic, and nylon. The solid material may also include a cellulosic fiber. The liquid carrier includes a solution of water and at least one glycol such as ethylene glycol, diethylene glycol, propylene glycol, triethylene glycol, dipropylene glycol, or tetraethylene glycol. The liquid carrier may also include additive agents such as antimicrobial agents, anti-corrosion agents, thickening agents, buffering agents, and adjuvant agents. The tire treatment composition of the present invention is suitable for use with a tire pressure management system or with nitrogen tire pressure systems and is supplied in a volume sufficient in a unit for treatment of the tires of a vehicle.

### FIELD OF THE INVENTION

This invention relates generally to chemical compositions for use as tire treatments to protect pneumatic tires from loss of inflation; and more specifically, to a flowable chemical composition including a solid component dispersed in a liquid carrier capable of sealing a tire against such a loss of inflation.

### BACKGROUND OF THE INVENTION

Pneumatic tires have been employed for a very long time to provide an efficient and durable means to support and cushion the ride of land vehicles over a wide variety of surfaces and terrain. However, just as long as pneumatic tires have been employed, problems associated with the loss of inflation have existed. Although tire technology has and will continue to improve over time, pneumatic tires remain susceptible to gradual and/or catastrophic loss of inflation.

In an effort to address the catastrophic loss of inflation of a vehicle pneumatic tire following a puncture, tear, or other such compromise of the tire that causes a loss of tire pressure, additive compositions have been developed in an effort to seal the puncture or hole. These compositions are often convenient, since the tire does not require substantive repair and can often be treated while on the vehicle even at a remote location. However, they are most often employed after the tire has already lost inflation such that the tire must be re-inflated prior to continued travel. A better option is a treatment composition that is applied within the vehicle tire before a puncture, or rupture occurs, so as to avoid the loss of inflation of the tire. A need also exists for a system of providing such a tire treatment composition in a volume and dispensing unit sufficient to treat all of the tires of a vehicle.

Conventional tire sealant compositions typically include a solid component dispersed in a liquid carrier wherein the solid component is intended to seal the tire against the gradual loss of tire pressure and before a puncture, tear, or rupture causes a catastrophic loss of inflation. In this way, the tire remains inflated and travel can continue until the puncture, tear or rupture can be addressed. Problems associated with conventional compositions include the fact that they have been known to pool on the inside of the tire. Such pooling affects the balance, and thereby the ride and rotation of the tire. In addition, known problems have been associated with the solid component not properly dispersing in the liquid carrier. As a result, the liquid carrier and a certain amount of the solid component have been known to escape the tire through a puncture or other rupture in the tire without the intended sealing of the tire. A need, therefore, exists for a tire treatment composition which evenly coats the inside of the tire and does not pool therein. A need also exists for a tire treatment composition which includes a solid component which disperses in the liquid carrier such that it properly seals a hole, puncture, or other rupture in the vehicle tire.

In addition, increases in fuel costs have directed attention to inefficiencies in vehicle fuel consumption. One such inefficiency is improperly inflated vehicle tires. As a result, tire pressure management systems are being employed in an effort to maintain proper vehicle tire inflation so as to maximize fuel economy. Also, inflation of tires with other gasses such as nitrogen, instead of air, is being employed. Such gasses, due to comparative molecular size, are employed in an effort to inhibit the gradual loss of inflation over time. Problems associated with the use of tire treatment compositions in association with tire pressure management systems are known in the art. Currently available tire treatment compositions have been known to clog tire pressure management systems and render them ineffective. A need exists for a tire treatment composition which is effective in sealing punctures as described above yet does not affect the operation of tire pressure management systems and are compatible with the use of alternate inflation gasses, such as nitrogen.

### SUMMARY OF THE INVENTION

The tire treatment composition of the present invention is added to a tire or all tires of a vehicle in order to protect the tire from the loss of inflation resulting from gradual escape and/or rapid escape resulting from a puncture. The inventive tire composition includes, in its very basic embodiment, a solid material component dispersed in a liquid carrier. The liquid carrier preferable comprises a solution of water and glycol. The solid material in the treatment composition includes, generally, a blend of ceramic and polymeric fibers.

The liquid carrier suspends and disperses the solid material in a vehicle tire in order to assist in the prevention of leakage of gas, such as air, nitrogen or the like contained within, and inflating the tire. In addition, the liquid carrier assists in the delivery of the solid material into a hole that may occur or be punctured in the tire so as to seal that leak and prevent the escape of gas contained within and inflating the tire.

The glycol portion of the liquid carrier acts, primarily, to hydrate the inside of the tire and as antifreeze for the treatment composition. As used herein, the term glycol with respect to the liquid carrier shall include all polyols, and particularly alkyl polyols. The liquid carrier includes water in the range of 5% and 75% by weight of the final composition and preferably in the range of 25% and 50%. The concentration of glycol in the liquid carrier is in the range of 5% and 75% by weight of the final composition and preferably in the range of 25% and 50%.

The liquid carrier may also include other additives, such as antimicrobial agents, anti-corrosion agents, thickening agents, buffering agents, and adjuvant agents. Preferably, the antimicrobial agent is in the concentration of 0.1% and 5% by weight of the treatment composition. The anti-corrosion agent is in the concentration of 0.5% and 10% by weight of the total treatment composition. The thickening agent is in the concentration of between 0.1% and 10% by weight of the total treatment composition. The buffering agent is in the concentration between 0.25% and 10% by weight of the total treatment composition. The adjuvant agent may be a dye, processing aid, or odor control agent and may be present in the concentration between 0.0025% and 3.0%.

The solid component of the tire treatment composition of the present invention forms the plug necessary to seal a leak in the vehicle tire. The solid component preferably includes at least one ceramic fiber combined with a blend of polymeric fibers. The polymeric fiber component is preferably a blend of polyethylene fibers, polypropylene fibers, and acrylic fibers, and, more preferably, a blend of several different polymeric fibers. The purpose of the blend of fibers is to provide a solid component which includes fibers of varying lengths, thicknesses, straight and tangled. Moreover, certain of the fibers are fibrillated.

The present invention also includes a delivery system for the tire treatment composition. In general, it is preferably to supply between eight (8) and sixteen (16) ounces of the composition per tire for average sized passenger cars. The composition is preferably supplied in a half-gallon container sufficient to treat four (4) tires of a typical passenger vehicle. Larger containers of 1 and 5 gallon may be provided for SUV's, small trucks and commercial vehicles. In addition to the container, the delivery system also includes a pump, flexible hose, and valve system.

The tire treatment composition of the present invention is particularly suitable for use with Tire Pressure Management Systems (TPMS). Specifically, it has been found that the tire composition of the present invention does not interfere with the operation of such systems.

The tire treatment composition of the present invention is also particularly suitable for use with nitrogen tire inflation systems. Nitrogen inflation systems for vehicle tires are becoming more popular. If a tire becomes punctured, or somehow loses nitrogen, there is a cost involved with refilling the tire. The present invention assists in preventing the loss of nitrogen.

It is thus an object of the present invention to provide a tire treatment composition that seals tube and tubeless tires against the loss of pressure.

It is a further object of the present invention to provide a tire treatment composition that seals tires against general or gradual loss of pressure over time.

It is still a further object of the present invention to provide a tire treatment composition that seals tires against the rapid loss of pressure due to a leak or puncture.

It is yet another object of the present invention to provide a tire treatment composition that seals punctures.

It is still another object of the present invention to provide a process for making the tire treatment composition.

It is an additional object of the present invention to provide a tire treatment composition which is compatible with nitrogen tire pressure systems.

It is a yet further object of the present invention to provide a tire treatment composition which is compatible with tire pressure management systems.

It is another object of the present invention to provide a delivery system for the tire treatment composition of the present invention.

Other objects and advantages of the tire treatment composition of the present invention will be understood by one of skill in the art from the following description and claims.

### DESCRIPTION OF THE PREFERRED EMBODIMENTS

Before explaining the present invention in detail, it is important to understand that the invention is not limited in its application to the details of the embodiments and steps described herein. The invention is capable of other embodiments and of being practiced or carried out in a variety of ways. It is to be understood that the phraseology and terminology employed herein is for the purpose of description and not of limitation.

In a first, basic, preferred embodiment a solid material component is dispersed in a liquid carrier. The liquid carrier in the preferred embodiment includes a solution of water and glycol. The solid material in the treatment composition includes, preferably, a synergistic blend of ceramic and polymeric fibers. The polymeric fibers may include a mixture of polyethylene and/or polypropylene, polyester, nylon polymeric acrylic fibers and/or like materials. The solid material may also include a cellulosic fiber.

The liquid carrier includes a solution of water and at least one glycol. The purpose of the liquid carrier is to suspend and disperse the solid material in a vehicle tire in order to assist in the prevention of the escape of gas, such as air, nitrogen or the like contained within, and inflating the tire. The escape of gas may be gradual over the course of time, such as at the seal with the wheel or valve stem, or it may be sudden and catastrophic, such as the result of a puncture or other such rupture of the tire. In addition, the liquid carrier assists in sealing the tire such as around the wheel and valve stem in order to arrest the gradual leak of gas from the tire. The liquid carrier also assists in the delivery of the solid material into the hole that may occur or be punctured in the tire so as to seal that leak and prevent the rapid escape of gas contained within and inflating the tire.

The glycol portion of the liquid carrier acts, primarily, to hydrate the inside of the tire and as antifreeze for the treatment composition. As used herein, the term glycol with respect to the liquid carrier shall include all polyols, and particularly alkyl polyols. The liquid carrier includes water in the range of 5% and 75% by weight of the final composition and preferably in the range of 25% and 50%. The concentration of glycol in the liquid carrier is in the range of 5% and 75% by weight of the final composition and preferably in the range of 25% and 50%. In the preferred embodiment, it has been found that suitable glycols may be ethylene glycol, diethylene glycol, propylene glycol, triethylene glycol, dipropylene glycol, or tetraethylene glycol.

The liquid carrier may also include other additives, such as antimicrobial agents (to prevent the growth of bacteria, fungus, mold, algae, etc.), anti-corrosion agents (to protect wheels, tire valves, pressure sensors and the like), thickening agents (to control viscosity and pumpability and to promote adhesion to the inside of the tire wall), buffering agents (to control the pH of the composition and to provide a reservoir of alkalinity for the anti-corrosion ingredients), and adjuvant agents (to aid in processing and application). Preferably, the antimicrobial agent is a compound selected from a group consisting of mixtures of materials trademarked as Dowacil, Ucarsan, Omacide, Proxel, Bioban, and Glutex. The anti-corrosion agents in the preferred embodiment are selected from the group consisting of salts, such as nitrites, borates, depolarizing film formers, amine compounds, and triazole compounds. The thickening agents in the preferred embodiment are selected from the group consisting of natural gums, polymers, and mixtures of natural materials and polymers. The preferred suitable buffering agents are mixtures of primary, secondary, and tertiary amines. The adjuvant agent may be a dye, processing aid, odor control agent, or processing aids. The additives in the liquid carrier in a preferred embodiment may be added in the following percentages by weight:

5%-75% and most preferably 25%-50% water;

5%-75% and most preferably 25%-50% ethylene glycol;

0.1%-5% and most preferably 0.2%-2% antimicrobial agents;

0.5%-10% and most preferably 1.0%-5% anti-corrosion agents;

0.1%-10% and most preferably 0.2%-5% thickening agents;

0.25%-10% and most preferably 0.5%-5% buffering agents;

0.025%-3% and most preferably 0.05%-2% adjuvant agents.

The solid component of the tire treatment composition of the present invention forms the plug necessary to seal a leak, puncture, tear or other such rupture in the vehicle tire. It also seals the tire to arrest slow gradual losses of inflation. The solid component includes at least one ceramic fiber component and a blend of polymeric fibers. The ceramic fiber component or components are larger particles helpful in initiating the plugging process. The polymeric fiber component is preferably a blend of polyethylene fibers, polypropylene polyester fibers, acrylic (polyacrylic) fibers, nylon, and like materials. The purpose of the blend of fibers is to provide a solid component which includes fibers of varying lengths, thicknesses, straight, and/or tangled. The polyethylene and/or polypropylene fibers are useful for providing various fiber sizes, while the acrylic fibers assist in forming an entanglement matrix and the polyester fibers offer different geometries to promote plugging.

A particularly effective mixture of said fibers in the preferred embodiment consists of a ceramic fiber having a diameter between 0.75 microns and 8.0 microns, and settle volume range of 100 to 600. [Settle volume is a well-known measurement used to indicate the physical dimensions of a fiber. A larger number indicates the fiber has larger physical dimensions such as diameter and/or length.]

The polymeric fiber component includes a synergistic blend of polymeric fibers which together with the ceramic component and dispersed in the liquid carrier are highly suitable to seal punctures in pneumatic tires. The polymeric fiber of the solid component includes in the preferred embodiment polyethylene, or polypropylene, or mixtures thereof. The preferred physical dimension of the polymeric fiber are in a range of 0.4 mm to 4.0 mm in length with a preferred range of 0.8 mm to 2.0 mm in length and a diameter range of 10 microns to 30 microns. The polymeric fiber of the solid component also includes a polymeric acrylic type in the preferred embodiment. The polymeric acrylic fiber includes in a preferred embodiment a fiber length range of 0.1 mm to 10.0 mm. and a range of 0.5 microns to 25 microns in diameter. Additionally, the polymeric fiber of the solid component preferably includes a polymeric fiber of the polyester type. The polyesterfiber of the preferred embodiment includes a fiber length range of 0.25 mm to 3.0 mm and a range of 0.5 microns to 2.5 microns in diameter. It should be understood that the types of polymeric fibers listed are illustrative of a preferred embodiment and not limiting.

The concentration of the solid component in the tire treatment composition of the present invention is most preferably from 1% to 5% by weight of the composition and most preferably from 2% to 4% by weight. It should be understood, however, that these stated weight percentages are illustrative and not limiting. The total weight of fibers in the composition is limited only by flowability or viscosity considerations.

An example of a particularly effective manufacture of the tire treatment composition of the present invention shall next be described. First, the ethylene glycol and water are added to a mixing vessel which is a properly sized plastic or stainless steel vessel fitted with a cone bottom configuration and provided with a straight over the side marine type of mixing blade. Agitation speed is adjusted to allow effective mixing. Next, the additive package, consisting of anti-corrosion ingredients, antimicrobial ingredients, pH-buffering ingredients, and rheology control ingredients, is added. The composition is then mixed to insure uniformity. Following the addition of the additive package to the liquid carrier, the fiber package is added. The fiber package consists of all of the fibers which have been previously mixed and dry blended in such a way as to insure consistency of the fiber package. Mixing is continued until the composition is smooth and uniform and contains no particles or lumps larger than about 3.0 mm.

After employing this process, a particularly suitable tire treatment composition results. It should be understood, however, to one of ordinary skill in the art that variations in this process are contemplated. The finished composition is an opaque whitish tannish/yellowish colored viscous liquid with a slight odor. It is dispersible with water and has some of the following properties: a density of about 8.5 lb/gal@25 C, a viscosity of about 2750 cps, a boiling point of greater than 212 F, a vapor pressure of about 770 mm Hg, an evaporation rate less than 1 (butyl acetate=1), a VOC content of about 45%, a flash point greater than 200 F, a pH range of from about 8.0 to about 11.0, and a particle size distribution such that there are no lumps larger than 3.0 mm. Various colorant agents may be added as desired or required.

The present invention also includes a delivery system for the tire treatment composition. The composition is preferably supplied in a half-gallon, 1 or 5 gallon containers sufficient to treat four (4) tires of a standard motor vehicle. In addition to the container, the delivery system also includes a pump, flexible hose, and valve system.

The tire treatment composition of the present invention is particularly suitable for use with Tire Pressure Management Systems (TPMS). Specifically, it has been found that the tire composition of the present invention does not interfere with the operation of such systems. Tire treatment management systems are becoming popular as a means to maximize the fuel efficiency of a vehicle, particularly as a result of increasing fuel costs. It is contemplated that government regulations in many nations will require such tire pressure management systems as an effort to conserve resources and limit pollution. Examples of such TPMS systems include direct tire pressure monitoring systems offered by Beru, Schrader, Pacific, and others, which include a pressure sensor/transmitter mounted to each wheel inside the tire's air chamber.

The tire treatment composition of the present invention is also particularly suitable for use with nitrogen tire inflation systems. Nitrogen inflation systems for vehicle tires are becoming more popular. If a tire becomes punctured, or somehow loses nitrogen, there is a cost involved with refilling the tire. The present invention assists in preventing the loss of nitrogen.

Thus, the present invention is well adapted to carry out the objects and attain the ends and advantages mentioned above as well as those inherent therein. While presently preferred embodiments have been described for purposes of this disclosure, numerous changes and modifications will be apparent to those skilled in the art. Such changes and modifications are encompassed within the spirit of this invention as defined by the appended claims.

What is claimed is:

1. A tire treatment composition including a solid material suspended in a liquid carrier wherein said solid material comprises:
at least one ceramic fiber component and a blend of polymeric fibers selected from the group consisting of polyethylene, polypropylene, polyester, nylon, and polymeric acrylic.

2. The tire treatment of claim 1 wherein said solid material further includes a cellulosic fiber.

3. The tire treatment composition of claim 1 wherein said solid material includes the following average size ranges:
ceramic fibers having a diameter between 0.75 and 8.0 microns and a settle volume of between 100 and 600;
polyethylene and/or polypropylene fibers having a diameter between 10 and 30 microns and a length between 0.4 mm and 4.0 mm;
polymeric acrylic fibers having a diameter between 0.5 and 25 microns and a length between 0.1 mm and 10 mm; and,
polyester fibers having a diameter between 0.25 microns and 2.5 microns and a length between 0.5 mm and 2.5 mm

4. The tire treatment composition of claim 1 wherein said solid material includes the following average size ranges:
ceramic fibers having a diameter between 0.75 microns and 8.0 microns and a settle volume between 100 and 600,
polyethylene and/or polypropylene fibers having a diameter between 10 microns and 30 microns and a length between 0.4 mm and 4.0 mm;
polymeric acrylic fibers having a diameter between 0.5 microns and 25 microns and a length between 0.1 mm and 10.0 mm and,
polyester fibers having a diameter between 0.5 microns and 2.0 microns and a length between 0.25 mm and 3.0 mm.

5. The tire treatment composition of claim 1 wherein said liquid carrier comprises a solution of water and at least one glycol selected from a group consisting of ethylene glycol, diethylene glycol, propylene glycol, triethylene glycol, dipropylene glycol, and tetraethylene glycol.

6. The tire treatment composition of claim 1 wherein said liquid carrier includes antimicrobial agents, anti-corrosion agents, thickening agents, buffering agents, and adjuvant agents.

7. The tire treatment composition of claim 6 wherein said antimicrobial agent is selected from a group consisting of mixtures of materials trademarked as Dowacil, Ucarsan, Omacide, Proxel, Bioban, and Glutex.

8. The tire treatment composition of claim 6 wherein said anti-corrosion agents are selected from the group consisting of salts, such as nitrites, borates depolarizing film formers, amine compounds, and triazoles.

9. The tire treatment composition of claim 6 wherein said thickening agent is selected from the group consisting of natural gums, polymers, and mixtures of natural materials and polymers.

10. The tire treatment composition of claim 6 wherein said buffering agents are amines.

11. The tire treatment composition of claim 6 wherein said adjuvants are selected from the group consisting of dyes, odor-control agents, and processing aids.

12. The tire treatment composition of claim 1 wherein said liquid carrier includes the following by weight percent of the composition:
5%-75% water
5%-75% ethylene glycol
0.1%-5% antimicrobial agents
0.5%-10% anti-corrosion agents
0.1%-10% thickening agents
0.25%-10% buffering agents
0.025%-3% adjuvant agents.

13. The tire treatment composition of claim 1 wherein said liquid carrier includes the following by weight percent of the composition:
25%-50% water
25%-50% ethylene glycol
0.2%-2% antimicrobial agents
1.0%-5% anti-corrosion agents
0.1%-5% thickening agents
0.5%-5% buffering agents
0.05%-2% adjuvant agents.

14. The tire treatment composition of claim 1 for use with a tire pressure management system.

15. The tire treatment composition of claim 1 for use with nitrogen tire pressure systems.

16. The tire treatment composition of claim 1 for use with a nitrogen tire pressure system and a tire pressure management system.

17. The tire treatment composition of claim 1, further including:
supplying the tire treatment composition of a volume sufficient in a unit for treatment of the tires of a vehicle.

18. The tire treatment composition of claim 17 wherein said unit includes a volume of approximately one-half gallon of the tire treatment.

19. The tire treatment composition of claim 17 wherein said apparatus for conveying said tire treatment into the tires of a vehicle comprises:
a pump in fluid communication with said volume of said tire treatment;
a hose in fluid communication with said pump;
a valve in fluid communication with said hose.
